(19) United States
(12) Patent Application Publication
(10) Pub. No.: US 2006/0178857 A1
(43) Pub. Date: Aug. 10, 2006

(54) Quasi-redundant smart sensing topology

(76) Inventor: Leandro G. Barajas, Rochester Hills, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/055,390

(22) Filed: Feb. 10, 2005

(51) Int. Cl. G06F 15/00

(52) U.S. Cl. 702/189

(57) ABSTRACT

A sensor apparatus includes a plurality of sensing elements within an integrated sensing package. Each sensing element is directed at sensing the same parameter. Each sensing elements operates under a principle that is unique from the others thereby providing individual parameter measurements that are substantially immune from common mode effects due to generic influences upon the sensing elements and may exhibit different failure modes. Sensing element signals are acquired, validated and fused within the integrated sensing package, preferably with micro-controller based circuitry. A single output from the sensor apparatus is communicated directly to a programmable logic controller, microprocessor or over a network or other bus.

### TECHNICAL FIELD

The present invention is related to sensing systems. More particularly, the present invention relates to so-called smart sensors.

### BACKGROUND OF THE INVENTION

Many sensing systems employ redundant sensing to improve the accuracy and robustness of their measurements. Such systems are characterized by a plurality of substantially identical sensors configured to measure a predetermined parameter. Essentially, redundancy is based upon simple repetition of the functionality of the same type of sensor either in the same or in different locations.

As illustrated in FIG. 1, each sensor (Sₙ) in such a redundant arrangement requires one of a limited number of inputs (Iₙ) at a microprocessor or programmable logic controller (PLC) 110. In other words, there is a one-to-one mapping of sensors to input points. Each sensor therefore requires significant processor or PLC system resources for such signal processing tasks as signal conditioning and filtering, analog-to-digital (A/D) conversion, error and offset compensations, linearization, data storage, etc. Of course, the more sensors used in a redundant array, the more processor resources are required and consumed.

In such redundant sensor arrangements, data fusion and validation are also performed by the microprocessor or PLC, thereby consuming even more of the limited processor resources and being subject to processor cycle delays and throughput constraints. Validating individual sensors among only a pair of sensors is difficult where no information about the sensors is available apart from the data at the inputs of the microprocessor or PLC. Simpler, analog systems may employ arithmetic averaging techniques to fuse the data from a pair of sensors. More robust systems employ three sensors and validate individual sensor data with covariance techniques. Of course, as alluded to, more sensors require more of the already limited input points and processor resources, consume additional space and provide additional system cost.

So-called smart sensors may alleviate some of the burden on the microprocessor or PLC by performing much of the signal processing in-situ (e.g. signal conditioning and filtering, analog-to-digital (A/D) conversion, error and offset compensations, linearization, data storage) and additionally provide communication and data buffering to and from the microprocessor or PLC. While this may eliminate the need for most custom post-processing at the microprocessor or PLC, a redundant sensor arrangement of such smart sensors still suffers from certain shortfalls and requires processor or PLC level validation. For example, conventional validation techniques are subject to generic influences upon the sensors, such as radio frequency interference (RFI) and electromagnetic interference (EMI), and will fail to diagnose such common mode issues. Spatial diversity of redundant sensors (i.e. diversity of sensor locations) has been employed in an attempt to address such generic influences. However, no practical degree of spatial diversity will lessen the influence of homogeneously distributed generic influences 115. If generic influences are concentrated or focused 120, spatial diversity may provide some relief; however, spatial diversity may not be practical or may introduce other sources of measurement error, particularly in spatially critical sensing applications such as localized parameter measurements wherein distribution of sensors is generally undesirable, impractical or irrational.

### SUMMARY OF THE INVENTION

The present invention overcomes the shortfalls of redundant sensing and spatial diversity. In accordance with the present invention, a sensor assembly for measuring a predetermined parameter includes a plurality of sensing elements. The sensing elements are integrated within a unitary sensor package. Each of the sensor elements is operative in accordance with a unique sensing principle to provide a respective measurement signal corresponding to the predetermined parameter. A signal processor is integrated within the unitary sensor package and is effective to fuse the respective measurement signals. The signal processor is also effective to provide a single sensor output signal based upon the measurement signals provided by the plurality of sensing elements that is indicative of the predetermined parameter. Each of the sensing elements is substantially immune from common mode effects due to influences which may operate upon all sensor elements. The signal processor may also provide conditioning and validation of the sensor element signals.

In accordance with a preferred implementation, the signal processor includes micro-controller circuitry including a storage medium having a computer program encoded therein. The computer program includes code for acquiring sensing element signals, code for conditioning sensing element signals, code for validating sensing element signals, and code for fusing the sensing element signals to provide an integrated sensor signal.

An exemplary embodiment of a temperature sensing application includes, for example, a thermistor, a thermocouple and a pyrometer as sensing elements. Preferably, the sensing element complement includes a non-contacting-type sensing element (e.g. pyrometer, thermal imagers and ratio thermometers) and a contacting-type sensing element (e.g. thermistor, thermocouple, and thermopile).

A method for sensing a predetermined parameter in accordance with the present invention includes providing a plurality of sensing elements within an integrated sensing package. At least two of the plurality of sensing elements are characterized by disparate sensing principles to provide respective sensing element signals corresponding to the predetermined parameter. The method also includes fusing the sensing element signals with processing circuitry within the integrated sensing package, and may further include validating the sensing element signals.

### BRIEF DESCRIPTION OF THE DRAWINGS

The drawings, which are understood to be exemplary of a preferred embodiment of the present invention and not limiting thereof, are now referred wherein:

FIG. 1 is a schematic block diagram of a redundant sensor system;

FIG. 2 is a schematic block diagram of a system including quasi-redundant smart-sensing in accordance with the present invention;

FIG. 3 is a detailed schematic block diagram of a quasi-redundant sensor in accordance with the present invention; and

FIG. 4 is a functional block diagram illustrating various operations carried out by the quasi-redundant sensor in accordance with the present invention.

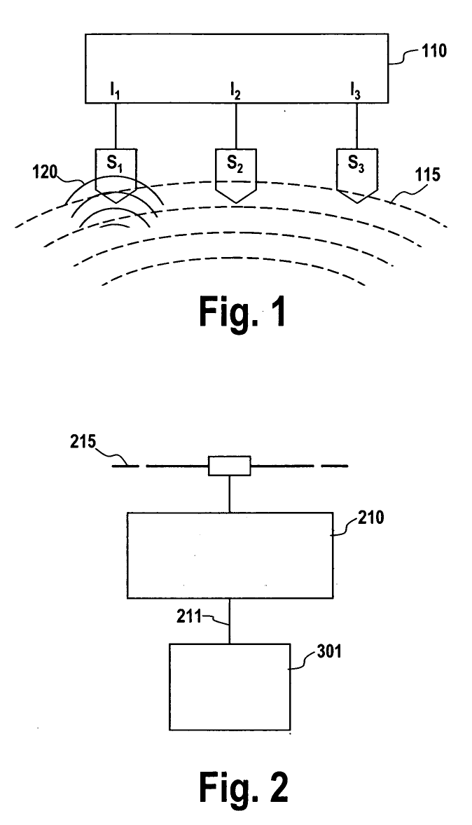

### DESCRIPTION OF THE PREFERRED EMBODIMENT

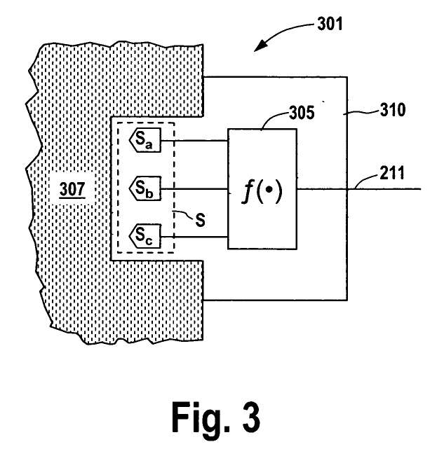

The present invention will now be described with reference to FIGS. 2 and 3 which illustrate an embodiment of a quasi-redundant, multi-element smart-sensor 301 in application with a microprocessor or PLC based control 210. Sensor 301 is shown in operative communication with control 210 via line 211 in the figure. Line 211 comprises any of a variety of appropriate communication means including hardwired or wireless communications. In hardwired communications, data transmission comprises serial or parallel data in accordance with the particular application. For example, high speed applications may benefit from parallel bus communication whereas in applications wherein high speed communication is not so critical, serial data transmission may be sufficient. Control 210 may be an independent control or part of a more complex network of additional controllers (not separately illustrated) communicating via any of a variety of bus/networks 215, including closed and open networks. Though not separately illustrated, sensor 301 may also be adapted for communication directly over network 215 or any intermediate network or bussed communication means.

With particular reference to FIG. 3, a plurality of sensor elements (S) includes a first sensor element Sₐ providing a measurement of a predetermined parameter of interest, for example temperature of a predetermined target such as an automobile engine block 307. Second and third sensor elements, S_{b} and S_{c}, also provide respective measurements of the same predetermined parameter. Preferably, each of the individual sensor elements Sₐ, S_{b} and S_{c} are co-located within an integrated package 310. The integrated package may comprise, for example, a unitary sensor body for installation and service in modular fashion. At least two of the plurality of sensor elements (S) are characterized by disparate measurement principles. For example, in the present exemplary embodiment for measurement of temperature, the first sensor element (Sₐ) comprises a thermistor, the second sensor element (S_{b}) comprises a thermocouple and the third sensor element (S_{c}) comprises a pyrometer. While temperature sensing is presently selected to illustrate the present invention, the present invention is applicable to any sensing including such non-limiting examples as pressure, flow, proximity, motion, etc. or any variants thereof. Whereas the thermistor (Sₐ) and the thermocouple (S_{b}) are both contact-type sensors, the pyrometer (S_{c}) is a non-contact-type sensor. Thermistor (Sₐ) is a thermally sensitive resistor that exhibits a change in electrical resistance with a change in its temperature. The resistance may be measured by passing a small, measured direct current through it and measuring the voltage drop produced. Thermocouple (S_{b}) includes a pair of dissimilar metal wires joined at one end to form a junction which generates a net thermoelectric voltage between the other ends according to the size of the temperature difference therebetween. Pyrometer (S_{c}) measures temperature from the amount of thermal electromagnetic radiation received from a region of the target of interest. As can now be appreciated, all three sensor elements exhibit disparate measurement principles. Preferably, the sensor elements are affected in substantially diverse manners by outside influences and environmental factors. For example, whereas thermocouple (S_{b}) may be undesirably affected or influenced by RFI and EMI, thermistor (Sₐ) and pyrometer (S_{c}) generally are not. Additionally, for example, whereas thermistor (Sₐ) and thermocouple (S_{b}) are subject to the thermal momentum of the contacted target and their own inherent thermal masses resulting in response time shortfalls, the pyrometer (S_{c}) is decoupled from such influences and exhibits a substantially more instantaneous temperature measurement capability. Each of the unique sensors is substantially decoupled one from the next with respect to certain undesirable environmental factors. Additionally, the disparate nature of the sensor elements may also manifest differences in failure modes and similar decoupling thereof.

Of course, more complex variants of simple sensors such as those exemplified above may be implemented as the sensing elements in accordance with the present invention, it being understood that the exhibition of disparate measurement principles should be retained. For example, a thermopile comprising a plurality of thermocouples may be used in place of or in conjunction with a single thermocouple. Also, a variety of pyrometer-based sensors includes two-dimensional thermal imagers and ratio thermometers, each of which may be used in place of or in conjunction with a simple pyrometer.

Signal processor circuitry 305 within the smart sensor 301 integrated package 310 provides for signal conditioning and filtering, analog-to-digital (A/D) conversion (as required), error and offset compensations, linearization, etc. of the plurality of sensors (S) signals. Additionally, data storage and communication and data buffering to and from the microprocessor or PLC may be provided by circuitry 305. Circuitry 305 may be implemented in completely analog fashion in certain applications. However, circuitry 305 is preferably microcontroller-based with conventional control and logic circuitry as required by the particular sensor application and includes a CPU, read-only and read-write memory devices in which are stored a plurality of routines for carrying out operations in accordance with the present invention, including routines for signal conditioning and filtering, error and offset compensations, linearization, etc. of the signals from the plurality of sensors (S). Circuitry 305 may also include, for example, such common input/output (I/O) circuitry including A/D and D/A converters, non-volatile memory devices, digital signal processors, mixed-mode circuitry, etc. Being processor-based, such circuitry can be custom programmed to satisfy specific system requirements and later reprogrammed or re-calibrated as needed.

Independent measurements from the plurality of sensors (S) are validated and fused inside the sensor in order to provide a reliable source of information to the controller 210. Such distributed processing relieves such processing functions from the controller 210 and advantageously eliminates the attendant throughput constraints and delays.

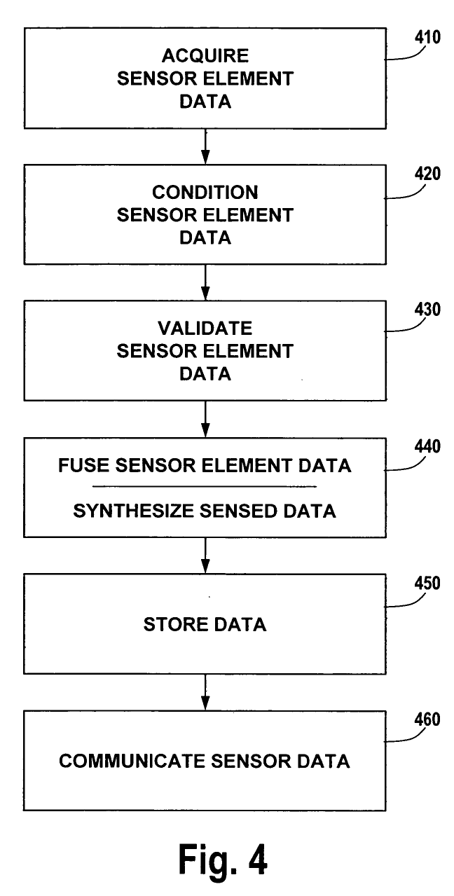

FIG. 4 illustrates certain exemplary operations preferably carried out by the microcontroller based circuitry 305 in accordance with the present invention and instruction sets stored, for example, in non-volatile memory devices. Though illustrated generally as a plurality of serial sub-operations 410 through 460, one skilled in the art will recognize that the operations are not necessarily carried out in such ordered fashion.

Beginning first with block 410, sensor element data acquisition includes steps necessary to read the individual sensors (Sₐ-S_{c}). Such steps may be performed on a regular basis such as through a conventional timer interrupt loop or through other irregular interrupts such as event based interrupts. The frequency of data acquisition will vary in accordance with such factors as the parameter being sensed and the measurement principle of the sensing element. This operation may further include provision of voltage or current to the sensor, for example a control current to a thermistor to enable acquisition of a resultant voltage. Additionally, multiplexing of the various sensor elements to a single input stage would require coordination and management at this point if employed.

Block 420 represents the conditioning of the sensor element data so acquired. For example, signal conditioning comprising conventional “debouncing”, filtering, averaging, error and offset compensations, linearization etc. are performed on the acquired data. Analog to digital conversion is also performed on the data as part of the signal conditioning. However, such A/D conversion may be performed at various points in the conditioning—and even validation—of the sensed data since often times certain operations are more complex in the digital domains and it may be preferable to process the data in the analog domain. Eventually, however, it is preferable to digitize analog sensor element data.

Next, block 430 represents validation of the individual sensor element data whereat the health of a particular sensor element may be checked. Such operation may include rationality checks based on stored data tables, recent historical sensor element data or quasi-covariance relative to the other commonly packaged sensor elements or a true co-variance relative to other similar sensor elements in a system employing redundant such sensor elements either as additional sensor elements either part of or apart from the same integrated package 301.

Validated sensor data can then be fused in any variety of known manners to achieve an integrated sensor output as illustrated at block 440. Various fusion frameworks ranging in complexity from simple correlative, through analytical to empirically learned, or hybrids thereof, can be utilized to fuse the sensor element data using, for example, Dempster-Shafer or Bayesian data fusion to aggregate signals acquired from different sources and even at different times. If desired, additional outputs are synthesized at this point also as required. For example, a power measurement can be obtained indirectly by measuring the current through and the voltage across an electric circuit or element and determining the electrical power as a function of current and voltage.

Block 450 next represents storage of data which may include individual sensor element data, fused and synthesized sensor data and any other data which may be used in the sensor operation, diagnostics and prognostics. Finally, block 460 represents communication management and data transfer between the smart sensor 301 and control 210 or other busses or networks 215.

The invention has been described with respect to certain preferred embodiments that are intended to be taken by way of illustration of the invention and not by way of limitation. For example, while the invention has been described with respect to an automotive engine temperature sensing application, it is equally applicable, with appropriate modifications, to other sensing applications.

1. Sensor assembly for measuring a predetermined parameter, comprising:
a plurality of sensing elements integrated within a unitary sensor package, each of said sensor elements operative in accordance with a unique sensing principle to provide a respective measurement signal corresponding to said predetermined parameter; and
a signal processor integrated within said unitary sensor package effective to fuse the respective measurement signals and further effective to provide a single sensor output signal based upon the measurement signals provided by the plurality of sensing elements that is indicative of said predetermined parameter.

2. The sensor assembly as claimed in claim 1 wherein said sensing elements are substantially immune from common mode effects from generic influences.

3. The apparatus as claimed in claim 1 wherein said signal processor is effective to validate said sensing element signals.

4. The apparatus as claimed in claim 1 wherein said signal processor is effective for conditioning said sensing element signals.

5. Sensor apparatus comprising:
at least two sensing elements integrated within a unitary sensor package, said at least two sensing elements characterized by disparate sensing principles to provide respective sensing element signals corresponding to a predetermined parameter;
micro-controller circuitry integrated within said unitary sensor package, said circuitry including a storage medium having a computer program encoded therein, said computer program including
code for acquiring said sensing element signals;
code for conditioning said sensing element signals;
code for validating said sensing element signals; and
code for fusing said sensing element signals to provide an integrated sensor signal.

6. The sensor apparatus as claimed in claim 5 wherein said predetermined parameter comprises temperature and said at least two sensing elements comprises a thermistor.

7. The sensor apparatus as claimed in claim 5 wherein said predetermined parameter comprises temperature and said at least two sensing elements comprises a pyrometer.

8. The sensor apparatus as claimed in claim 5 wherein said predetermined parameter comprises temperature and said at least two sensing elements comprises a thermocouple.

9. The sensor apparatus as claimed in claim 5 wherein said predetermined parameter comprises temperature and said at least two sensing elements comprises at least one contacting-type temperature sensing element and at least one non-contacting-type temperature sensing element.

10. The sensor apparatus as claimed in claim 9 wherein said at least one contacting-type temperature sensing element comprises at least one of a thermocouple, thermistor, thermopile and combinations thereof.

11. The sensor apparatus as claimed in claim 9 wherein said at least one non-contacting-type temperature sensing element comprises at least one of a pyrometer, thermal imager, ratio thermometer and combinations thereof.

12. The sensor apparatus as claimed in claim 5 wherein said code for fusing said sensing element signals includes code for synthesizing a measure of the predetermined parameter as a function of the respective sensing element signals from said at least two sensing elements.

13. The sensor apparatus as claimed in claim 5 wherein said predetermined parameter comprises electrical power, said at least two sensing elements comprises a voltage sensor and a current sensor, and said code for fusing said sensing element signals includes code for synthesizing electrical power as a function of current and voltage.

14. Method for sensing a predetermined parameter comprising:
providing a plurality of sensing elements within an integrated sensing package, at least two of said plurality of sensing elements being characterized by disparate sensing principles to provide respective sensing element signals corresponding to said predetermined parameter; and
fusing said sensing element signals with processing circuitry within said integrated sensing package.

15. The method for sensing a predetermined parameter as claimed in claim 14 further comprising:
validating said sensing element signals.
